(19) United States
(12) Patent Application Publication
(10) Pub. No.: US 2016/0371807 A1
(43) Pub. Date: Dec. 22, 2016

(54) DISPLAY PANEL AND DISPLAY APPARATUS INCLUDING THE DISPLAY PANEL

(71) Applicant: SAMSUNG DISPLAY CO., LTD., Yongin-si (KR)

(72) Inventors: Ja Hun Koo, Yongin-si (KR); Dae Yun Koo, Yongin-si (KR); Kyung Hun Lee, Yongin-si (KR); Woon Rok Jang, Yongin-si (KR)

(21) Appl. No.: 15/170,791

(22) Filed: Jun. 1, 2016

(30) Foreign Application Priority Data
Jun. 19, 2015 (KR) 10-2015-0087352

(51) Int. Cl. G06T 1/20; G09G 3/20

(52) U.S. Cl. CPC G06T 1/20; G09G 3/2096

(57) ABSTRACT

A display panel in which a graphic processing unit (GPU) of a personal computer (PC) is directly connected to a timing controller (T-Con) to exchange control signals, and a display apparatus including the display panel. The display panel includes a timing controller converting a video signal, an LED converter controlling an LED output based on a control of the timing controller, and a TFT pixel array displaying an image on a screen based on the control of the timing controller, wherein the T-Con is directly connected to a GPU of a PC, and transmits and receives a control signal to display the image on the screen.

### CROSS-REFERENCE TO RELATED APPLICATION

This application claims priority to and the benefit of Korean Patent Application No. 10-2015-0087352, filed on Jun. 19, 2015, in the Korean Intellectual Property Office, the entire content of which is incorporated herein by reference in its entirety.

### BACKGROUND

1. Field

The following description relates to a display panel, and a display apparatus including the display panel.

2. Description of the Related Art

In general, a display apparatus (a display device or a computer monitor set) 100 connected to a personal computer (PC) 200 may include a scaler 110, a display panel 120 and a power source block 130 as shown in FIG. 1.

In a related art display apparatus (display device) 100, a video signal processing may be implemented as follows. The display apparatus 100 receives video signals (signals depending on different standards e.g., DVI, HDMI and/or Display Port (DP)) in various formats from the graphic processing unit (GPU) 210 through a signal RX block 111 of the scaler 110. The display apparatus 100 implements a scaling and a color offset correction on video signals input from a video processor 112 of the scaler 110 to generate a video signal in a new format (signals based on standards such as LVDS, V by One, eDP, etc.). The display apparatus 100 transmits the video signals generated from a signal TX block 113 of the scaler 110 to a timing controller 121 disposed inside a display panel 120. The timing controller 121 may display a video by transmitting the input video signal in a thin film transistor (TFT) pixel array 122.

The display panel 120 may include a light emitting diode (LED) bar 123 which is operated by an LED converter 140 inside the display apparatus 100 in a pulse width modulation (PWM) or an analog dimming manner. The LED bar 123 may be controlled with the LED converter 140 when adjusting a level of brightness.

If the display apparatus 100 supports an on-screen display (OSD), the OSD function may be controlled by the scaler 110 and the OSD function control is implemented by exchanging control signals between a OSD controller, the scaler 110 and the display panel 120.

Further, the display apparatus 100 receives an AC power source from an AC power source 300 through a power source block 130 and the power source block 130 may convert the AC power into a DC to be supplied to each corresponding device (composition) disposed inside the display apparatus 100.

As described above, the related art display apparatus 100 uses an A/D board of the scaler 110 in order to support various input interfaces such as signal conversion (video signal conversion and AC/DC conversion etc.), video signal scaling, and on-screen display (OSD), which increase the manufacturing cost of the display apparatus 100. Recently, the standards for energy consumption on the display apparatus 100 of Energy Star Display 7.0 and China Energy Label CEL 2.0 were strengthened which makes it more difficult to meet the standards for energy consumption level of the display apparatus 100.

In addition, most of display apparatus 100 supports an analog RGB input to support the RGB interface which was mostly used in conventional CRT display apparatus, however, the GPU 210 of most of the current PCs 200 supports a digital interface (e.g., HDMI, DP, etc.) and the display panel 120 is also operated by the digital interface, thereby reducing the utility of the A/C board of the scaler 110. In particular, when using the analog RGB interface, quality degradation and noise issues may generate. As such, the related art display apparatus 100 is unnecessarily supporting the analog RGB input.

### SUMMARY

Aspects of embodiments of the present invention are directed toward solving the above described issues by providing a display apparatus including a display panel exchanging control signals by removing the above described scaler mediating the control and the connection between a graphic processing unit (GPU) and a timing controller and by directly connecting the GPU with the timing controller.

Aspects of embodiments of the present invention are directed toward a display panel in which a GPU of a personal computer (PC) is directly connected to a timing controller (T-Con) of the display panel to exchange control signals, and a display apparatus including the display panel.

In an embodiment of the present invention, to solve the above-described difficulties, provided is a display panel which includes a timing controller configured to convert a video signal; a light emitting diode (LED) converter configured to control an LED output based on a control of the timing controller; and a thin film transistor (TFT) pixel array configured to display an image on a screen based on the control of the timing controller, wherein the timing controller is directly connected to a graphic processing unit (GPU) of a personal computer (PC), and configured to transmit and receive control signals to display the image on the screen.

In another embodiment of the present invention, to solve the difficulties, the display apparatus includes a display panel including a timing controller configured to convert a video signal, an LED converter configured to control an output of an LED based on a control of the timing controller, and a TFT pixel array configured to display an image on a screen based on the control of the timing controller; and a power block configured to receive power from an external device and to supply the power to the display panel, wherein the timing controller is directly connected to a GPU of a PC, and configured to transmit and receive control signals to display the image on the screen.

In an embodiment of the present invention, the display panel, display apparatus including the display panel may reduce the cost of using the A/D board of the scaler from the related art display apparatus and meet the strengthened energy consumption regulation standard, thereby enhancing the market competitiveness and cost saving.

### BRIEF DESCRIPTION OF THE DRAWINGS

Example embodiment will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a display apparatus structure according to a related art technology;

FIG. 2 is a diagram illustrating another structure of a display apparatus according to an embodiment of the present invention.

FIG. 3 is a diagram illustrating a method for controlling a display apparatus according to a first embodiment of the present invention.

FIG. 4 is a diagram illustrating a method for controlling a display apparatus according to a second embodiment of the present invention.

FIG. 5 is a diagram illustrating a method for controlling a display apparatus according to a third embodiment of the present invention.

FIG. 6 is a diagram illustrating a method for controlling a display apparatus according to a fourth embodiment of the present invention.

FIG. 7 is a diagram illustrating a method for controlling a display apparatus according to a fifth embodiment of the present invention.

### DETAILED DESCRIPTION

Hereinafter, various examples of the embodiments will be described in more detail with reference to the accompanying drawings.

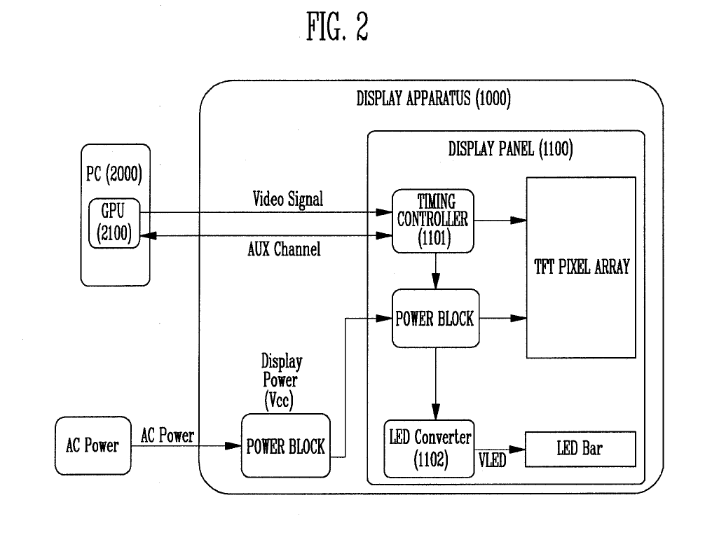

FIG. 2 is a diagram illustrating a structure of a display apparatus according to an embodiment of the present invention.

Referring to FIG. 2, a display apparatus 1000 may include a display panel 1100, and the display panel 1100 may include a timing controller 1101.

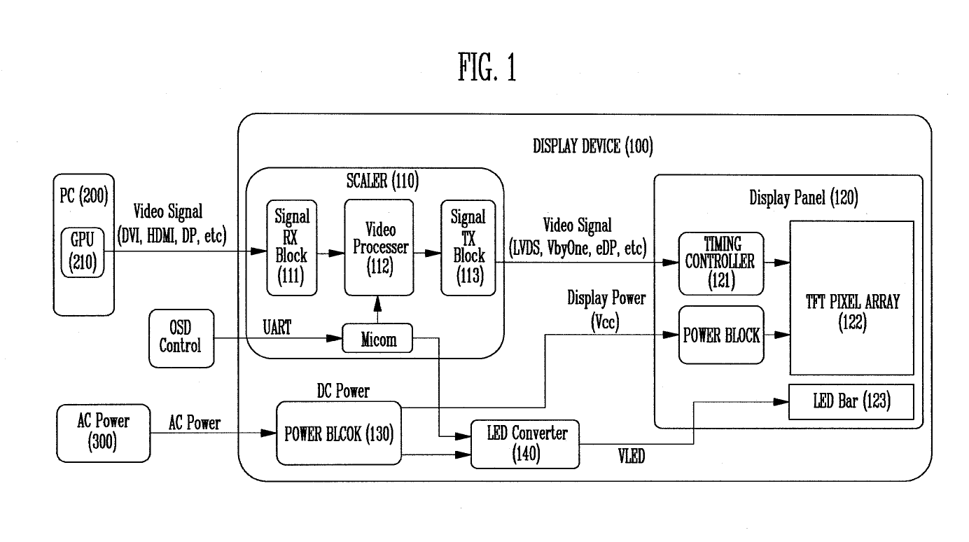

As illustrated in FIG. 2 and unlike the related art display apparatus shown in FIG. 1, the display apparatus 1000 according to an embodiment does not include a scaler 110. According to the embodiment of the present invention, the display apparatus 1000 receives and transmits control signals from and to a graphic processing unit (GPU) 2100 of a personal computer (PC) using a timing controller 1101 directly connected to the GPU 2100. Control signals may include digital interface signals and be received and transmitted through Display Port (DP) and/or HDMI.

The timing controller 1101 may receive video signals from the GPU 2100 and convert the video signals to transmit to a thin film transistor (TFT) pixel array 1104. To be specific, the timing controller 1101 may transmit to signal sources such as IC, PMI (which may control the TFT pixel array as a source IC, PMI of the TFT pixel array 1104). The TFT pixel array 1104 may display images on a screen depending on input signals.

In various embodiments of the present invention, the GPU 2100 and the timing controller 1101 may directly implement a scaling of the video signals and a color offset correction, which were operated in a related art scaler. In other words, in various embodiments of the present invention, scaling of the video signals may be performed at the GPU 2100 of the PC 2000 or may be embedded and performed in the timing controller 1101 of the display apparatus 1000.

In an embodiment of the present invention, the GPU 2100 through (via) the timing controller 1101 may load display information (e.g., Extended Display Identification Data—EDID) of the display apparatus 1000 (display panel 1100) and scale the display information of the display apparatus 1000 in an appropriate manner to output. To this end, the GPU 2100 may directly receive the display information from the timing controller 1101 and the display information may be transmitted through an interface directly connecting the GPU 2100 with the timing controller 1101. In an embodiment, the display information may be transmitted through an AUX channel of a DP directly connecting the GPU 2100 and the timing controller 1101.

In an embodiment of the present invention, the timing controller 1101 may directly perform a scaling on the video signals if a particular video signal has standards that fail to correspond to the display information of the display apparatus 1000 from the GPU 2100.

In various embodiments of the present invention, the GPU 2100 and the timing controller 1101 may directly control an on-screen display (OSD) function which could be performed in the related art scaler.

In an embodiment of the present invention, if a display control demand is input through an OSD window displayed on the display apparatus 1000, the timing controller 1101 may transmit a control signal corresponding to the display control demand to the GPU 2100. The control signal may be transmitted through the AUS channel of the DP directly connecting the GPU 2100 with the timing controller 1101. The GPU 2100 may process video signals depending on input control signals. Display control operations according to the OSD control signals may be brightness control, saturation control, contrast control, color and/or RGB control, size (width and height) control and/or position control.

In an embodiment of the present invention, among the display control operations using the OSD window, the timing controller may perform the brightness control. In this case, if a brightness control demand is input using the OSD window displayed on the display apparatus 1000, the timing controller 1101 may respond to the brightness control demand and process the video signal.

The display panel 1100 may include a light emitting diode (LED) converter 1102 controlling an output of the LED bar 1103 (controlling a backlighting) of the display panel 1100 in response to a control signal from the timing controller 1101.

Hereinafter, a method for controlling a display using an OSD window by receiving and transmitting control signals between the GPU 2100 of the PC 2000 and the timing controller 1101 of the display apparatus 1000 according to an embodiment of the present invention.

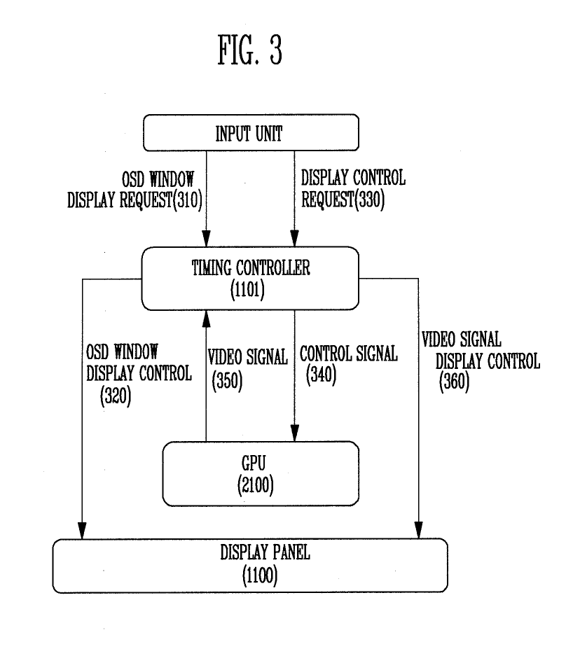

FIG. 3 is a diagram illustrating a method for controlling a display apparatus according to a first embodiment of the present invention.

Referring to FIG. 3, if a request for displaying an OSD window is input (310), the timing controller 1101 may control (320) the display panel 1100 to display the OSD window. Hereinafter, the timing controller controlling the display panel may refer to controlling the LED converter 1102 or the TFT pixel array 1104 and it may also be interpreted as controlling the screen displayed to a user from the display apparatus 1000.

An input unit may include a key pad, a dome switch, a touch pad (static pressure/electrostatic), a jog wheel, and/or a jog switch. An OSD display request may be generated by clicking the key pad, the dome switch, the touch pad, and/or the jog switch included in the input unit. The OSD window may include an icon, a text, and/or an image—showing a selected menu for a display control (brightness) adjustment, a saturation adjustment, a contrast adjustment, a color and/or RGB adjustment, and/or a size and/or position (width and/or height) adjustment.

If a request for the display control is input (330) using the OSD window displayed through the input unit, the timing controller 1101 may recognize the display control request and transmit (340) a corresponding control signal to the GPU 2100. In an embodiment of the present invention, the control signal may be transmitted through the AUX channel of the DP connecting the GPU 2100 and the timing controller 1101.

The GPU 2100 may process and transmit (350) a video signal to the timing controller 1101. The timing controller 1101 may control (360) the display panel 1100 to display the video signal that was received. Also, the timing controller 1101 may renew the OSD window based on results after processing the display control request.

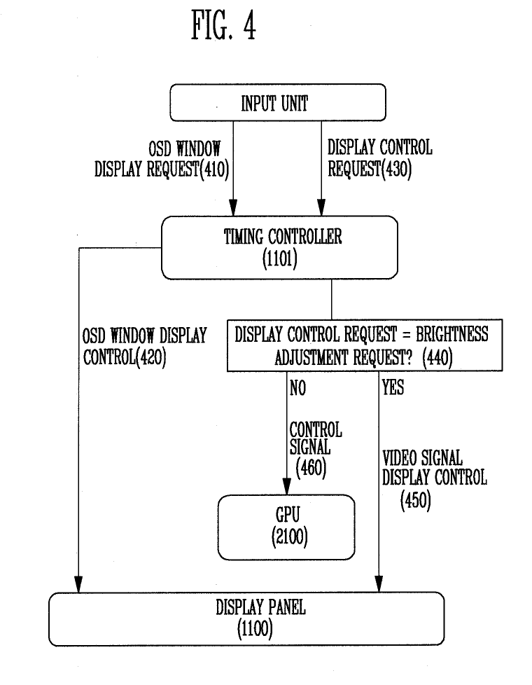

As described above, according to a first embodiment of the present invention, the GPU 2100 may implement the processing of the video signal to control the display using the OSD window. On the other hand, in the second embodiment of the present invention, the timing controller 1101 may directly process the video signal as shown in FIG. 4.

FIG. 4 is a diagram illustrating a method for controlling a display apparatus according to the second embodiment of the present invention.

Referring to FIG. 4, if a display control request is input through an input unit, the timing controller 1101 may process the video signal in response to the display control request.

In an embodiment, the timing controller 1101 may directly process the video signal if the display control request is a request for adjusting the brightness. To be more specific, if an OSD window display request is input (410) through the input unit, the timing controller 1101 may control (420) the display panel 1100 to display the OSD window. Then, if the display control request is input (430) by using the OSD that is displayed, the timing controller 1101 may determine (440) whether the display control request is a request for adjusting the brightness.

If the display control request is a request for adjusting the brightness, the timing controller 1101 may directly control (450) the display panel 1100 in response to the display control request. To be more specific, the timing controller 1101 may control the LED converter 1102 in response to the display control request and adjust the back light dimming by operating the LED bar 1103 in a pulse width modulation (PWM) manner and/or an analogue dimming manner. Also, the timing controller 1101 may renew the OSD window by reflecting the result after processing the display control request.

If the display control request is not a request for adjusting the brightness, the timing controller 1101 may control (460) the display by exchanging the control signal with GPU 2100.

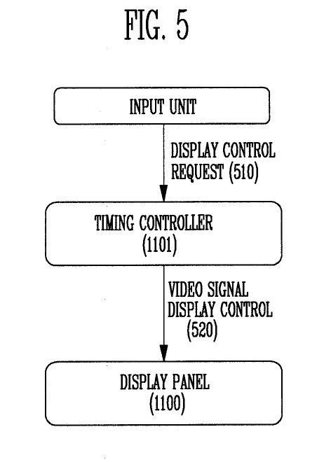

In a third embodiment of the present invention, the display apparatus 1000 may provide a brightness adjusting function among other OSD functions. FIG. 5 is a diagram illustrating a method for controlling a display apparatus according to the third embodiment of the present invention. In the third embodiment, once a display control request using the OSD window, in other words a request for adjusting the brightness is input (510), as shown in FIG. 5, the timing controller 1101 may directly control (520) the display panel 1100 in response to the display control request.

In the third embodiment, the GPU 2100 may not engage in the display control of the OSD function.

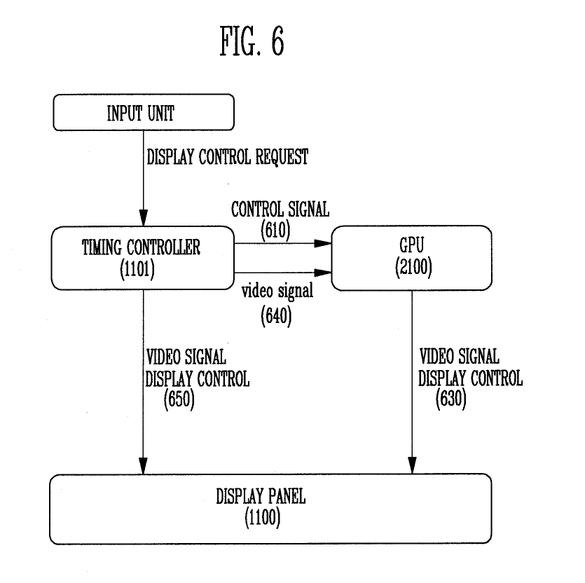

FIG. 6 shows a fourth embodiment of the present invention illustrating a method for controlling the display apparatus.

Referring to FIG. 6, the display control by the OSD function may control the display of the video signal by directly transmitting the video signal processed from GPU to the display panel 1100.

To be more specific, the GPU 2100 may directly control (630) the display panel 1100 based on the control signal input (610) from the timing controller 1101.

In an embodiment, if a control signal received from the GPU 2100 is a control signal to adjust the brightness, the display panel may control the signal. If a control signal is received, the GPU 2100 may determine whether the received control signal is a signal to adjust the brightness.

If the received control signal is to adjust the brightness, the GPU 2100 may control the display panel according to the control signal. To be more specific, the GPU may transmit the video display control signal to the LED converter 1102 to control the LED converter 1102 and adjust the backlight dimming by having a LED bar 1103 to operate in a PWM or in an analog dimming manner.

If the received signal is not a control signal to adjust the brightness, GPU 2100 may process the video data according to the control signal as shown in the first embodiment illustrated in FIG. 3 and may transmit (640) the video signal to the timing controller 1101. In this case, the timing controller 1101 may control (650) the display panel 1100 to display video signal that has been received.

As described above, in the fourth embodiment, the GPU 2100 may not transfer signals to the timing controller 1101 and instead directly control the display apparatus 1000.

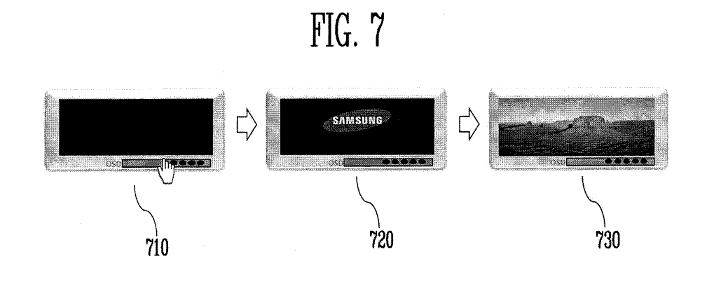

FIG. 7 is a method for controlling the display apparatus according to a fifth embodiment of the present invention. The fifth embodiment illustrates a method for controlling the initialization screen display when initializing the operation of the display apparatus 1000.

Referring to FIG. 7 the display apparatus may display an initialization screen prestored from the fail safe section through the input unit provided by the display apparatus 1000 when the display apparatus 1000 is in an on state. At that time, the initialization screen may be SET LOGO and in an embodiment, the SET LOGO may be set by an EEPROM of the timing controller or a BIST PTN of the Flash Memory. The fail safe period may output the SET LOGO (720) from an initial black display output section (710) before outputting a normal screen (730) if the display apparatus 1000 is an eDP model.

Expressions such as “at least one of” or “at least one selected from” when preceding a list of elements, modify the entire list of elements and do not modify the individual elements of the list. Further, the use of “may” when describing embodiments of the present invention refers to “one or more embodiments of the present invention.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section, without departing from the spirit and scope of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected to, coupled to, or adjacent to the other element or layer, or one or more intervening elements or layers may be present. In contrast, when an element or layer is referred to as being “directly on,” “directly connected to”, “directly coupled to”, or “immediately adjacent to” another element or layer, there are no intervening elements or layers present.

As used herein, the terms “use,” “using,” and “used” may be considered synonymous with the terms “utilize,” “utilizing,” and “utilized,” respectively.

The display apparatus and/or any other relevant devices or components according to embodiments of the present invention described herein may be implemented utilizing any suitable hardware, firmware (e.g. an application-specific integrated circuit), software, or a combination of software, firmware, and hardware. For example, the various components of the apparatus may be formed on one integrated circuit (IC) chip or on separate IC chips. Further, the various components of the apparatus may be implemented on a flexible printed circuit film, a tape carrier package (TCP), a printed circuit board (PCB), or formed on one substrate. Further, the various components of the apparatus may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention. Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims, and equivalents thereof.

What is claimed is:

1. A display panel, comprising:
a timing controller configured to convert a video signal;
a light emitting diode (LED) converter configured to control an LED output based on a control of the timing controller; and
a thin film transistor (TFT) pixel array configured to display an image on a screen based on the control of the timing controller,
wherein the timing controller is configured to be directly connected to a graphic processing unit (GPU) of a personal computer (PC), and to transmit and receive control signals to display the image on the screen.

2. The display panel of claim 1, wherein the timing controller is directly connected to the GPU through a digital interface, and the digital interface includes a display port (DP) and/or an HDMI.

3. The display panel of claim 1, wherein the timing controller is configured to transmit the video signal received from the GPU to the TFT pixel array by scaling the video signal to correspond to display information of the display panel.

4. The display panel of claim 1, wherein the timing controller is configured to transmit display information of the display panel to the GPU and to receive the video signal scaled based on the display information from the GPU.

5. The display panel of claim 1, wherein the timing controller is configured to implement controlling of an on-screen display (OSD) function.

6. The display panel of claim 5, wherein the timing controller is configured to control the TFT pixel array to display an on-screen display (OSD) window when an OSD window display request is input and to control the TFT pixel array or the LED converter in response to a display control request when the display control request is input through the OSD window.

7. The display panel of claim 6, wherein the display control request is a brightness control request, and the timing controller is configured to control the LED converter in response to the brightness control request.

8. The display panel of claim 5, wherein the timing controller is configured to control the TFT pixel array to display an on-screen display (OSD) window when an OSD window display request is input and to transmit a control signal to the GPU when a display control request is input through the OSD window.

9. The display panel of claim 8, wherein the timing controller is configured to receive the video signal, processed in response to the control signal, from the GPU and to transmit the video signal to the TFT pixel array by converting the video signal.

10. The display panel of claim 8, wherein the LED converter is configured to receive a display control signal from the GPU in response to the control signal.

11. A display apparatus comprising;
a display panel including a timing controller configured to convert a video signal, a light emitting diode (LED) converter configured to control an output of an LED based on a control of the timing controller, and a thin film transistor (TFT) pixel array configured to display an image on a screen based on the control of the timing controller; and
a power block configured to receive power from an external device and to supply the power to the display panel,
wherein the timing controller is configured to be directly connected to a graphic processing unit (GPU) of a personal computer (PC), and to transmit and receive control signals to display the image on the screen.

12. The display apparatus of claim 11, wherein the timing controller is configured to transmit the video signal received from the GPU by scaling the video signal to correspond to display information of the display panel to the TFT pixel array.

13. The display apparatus of claim 11, wherein the timing controller is configured to implement controlling of an on-screen display (OSD) function.

14. The display apparatus of claim 13, wherein the timing controller is configured to control the TFT pixel array to display an on-screen display (OSD) window when an OSD window display request is input and controls the TFT pixel array or the LED converter in response to a display control request when the display control request is input through the OSD window.

15. The display apparatus of claim 14, wherein the display control request is a brightness control request, and the timing controller is configured to control the LED converter in response to the brightness control request.

16. The display apparatus of claim 13, wherein the timing controller is configured to control the TFT pixel array to display an on-screen display (OSD) window when an OSD window display request is input and to transmit a control signal to the GPU when a display control request is input through the OSD window.

17. The display apparatus of claim 16, wherein the timing controller is configured to receive the video signal, processed in response to the control signal, from the GPU and to transmit the video signal to the TFT pixel array by converting the video signal.

18. The display apparatus of claim 16, wherein the LED converter is configured to receive a display control signal from the GPU in response to the control signal.

19. The display apparatus of claim 18, wherein the timing controller is directly connected to the GPU through a digital interface, and the digital interface includes a display port (DP) and/or an HDMI.

20. The display apparatus of claim 18, wherein the timing controller is configured to transmit display information of the display panel to the GPU and to receive the video signal scaled based on the display information from the GPU.
